(19) United States
(12) Patent Application Publication
(10) Pub. No.: US 2023/0366144 A1
(43) Pub. Date: Nov. 16, 2023

(54) AEROGEL BLANKET MANUFACTURING METHOD AND AEROGEL BLANKET THEREBY

(71) Applicant: Young Soo CHO, Changwon-si, Gyeongsangnam-do (KR)

(72) Inventors: Young Soo CHO, Changwon-si, Gyeongsangnam-do (KR); Youn Su JO, Seoul (KR); Min Chul KIM, Busan (KR)

(73) Assignee: Young Soo CHO, Changwon-si, Gyeongsangnam-do (KR)

(21) Appl. No.: 18/030,077

(22) PCT Filed: Oct. 7, 2021
(86) PCT No.: PCT/KR2021/013820

§ 371 Date: Apr. 4, 2023

(30) Foreign Application Priority Data
Oct. 8, 2020 (KR) 10-2020-0130449

(51) Int. Cl. D06M 15/59; D06M 23/14; C01B 33/157

(52) U.S. Cl. CPC D06M 15/59; D06M 23/14; C01B 33/157

(57) ABSTRACT

Disclosed are an aerogel blanket production method and an aerogel blanket produced thereby, the aerogel blanket production method including steps of: preparing a blanket; preparing a liquid raw material for aerogel formation with which the blanket is to be impregnated; impregnating the blanket with the liquid raw material; and gelling the impregnated liquid raw material to form aerogel, wherein a step of performing pre-processing on the blanket before the gelling of the liquid raw material is completed. The step of performing pre-processing may be performed after the step of preparing the blanket but before impregnating with the liquid raw material, or may be performed when the impregnated liquid raw material is in a flowable semi-liquid state before the liquid raw material is not completely converted into aerogel.

### TECHNICAL FIELD

The present invention relates to a method for producing an aerogel blanket, and more particularly, to a method for producing an aerogel blanket, which may increase the convenience of application after producing an aerogel blanket material in which aerogel particles have not been controlled, and an aerogel blanket produced by the method.

### BACKGROUND ART

The extremely low thermal conductivity of aerogel used as an insulator is due to its high porosity and its unique nanoporous structure blocking the movement of air molecules that may occur in the gas phase. These aerogels are made of various materials and have various physical properties, but in general, silica aerogels are often used. An aerogel blanket, which is made by impregnating a base material with aerogel, has an excellent insulation effect due to its high porosity, but the solid aerogel in the fibrous base material is sometimes chopped. In addition, in the application of the aerogel blanket, the aerogel blanket is damaged by external impact, or in the process of bending or cutting the aerogel blanket, very small particles are scattered around the workspace. Aerogel particles present in a dusty state make it difficult to attach a specific film or adhesive to the surface of the aerogel blanket, and when the aerogel particles are separated from the blanket, the insulation function is often weakened, and thus there are many difficulties in producing an aerogel blanket material or manufacturing a product using this aerogel blanket material and processing the product for applications.

In order to prevent aerogel (aerogel impregnated in a composite structure) particles from contaminating the workspace and from making work difficult, a blanket may also be made by covering the aerogel particles with a cover made of a material through which the aerogel particles cannot pass. However, in this case, damage to the cover itself, bias of the aerogel within the cover, and the like may be problems.

Korean Patent No. 10-1912011, Korean Patent No. 10-1912455, Korean Patent No. 10-1909174, Korean Patent No. 10-1079308, etc. disclose a method of producing an insulation blanket to solve or mitigate these problems. In these patent documents, as shown in FIG. 1 or 2, an aerogel layer is divided into small compartments in the entire area of the blanket and is defined therein, and the compartments are separated from each other by a separation region having a certain width. However, even in these technologies, problems in processing of the blanket still remain, and forming such a configuration itself is often an expensive and effortful process.

In recent years, aerogel has been often used in the form of an aerogel blanket obtained by impregnating a fibrous blanket with aerogel and performing an aerogel formation process. FIG. 3 is a flow chart showing each step in an example of a conventional method for producing an aerogel blanket. Here, the method comprises the following sequential steps of: preparing a fibrous blanket; preparing a liquid aerogel raw material with which the fibrous blanket is to be impregnated; impregnating the fibrous blanket with the liquid aerogel raw material; and gelling the liquid aerogel raw material in the fibrous blanket impregnated with the liquid aerogel raw material, and then subjecting the resulting structure to an atmospheric pressure process or a supercritical process, thereby producing an aerogel blanket.

However, even in this case, problems arise in that, in the process of cutting and sewing the finished aerogel blanket material to apply the aerogel blanket material to a processed product or to make a processed product using the aerogel blanket material, the aerogel impregnated in the fibrous blanket is broken into small particles, thus contaminating the workplace, and is separated from the blanket, making product production difficult and reducing the thermal efficiency of a finished product.

Therefore, it is important and necessary to provide a method of always preventing separation and detachment of aerosol particles from the blanket in the process of making the aerogel blanket into a component material that may be applied to various fields.

In addition, processing the aerogel blanket material is always a difficult operation due to the aerogel impregnated in the fibrous blanket, regardless of whether it is cutting, sewing, or molding. Thus, there is a demand for a method capable of mitigating these problems and increasing workability.

The present applicant has also developed and applied a technology such as adding a post-processing process during production so that the aerogel blanket is not used without blowing dust when it is used as a general industrial insulation material or applied to various industrial fields. In particular, molding and surface processing technologies have been applied as post-processing technologies to prevent aerogel dust generation and maintain uniform insulation performance, even in situations where processed aerogel blanket products are repeatedly crumpled, folded, and rolled. However, there have been problems in that aerogel dust is scattered, and productivity is reduced and the production cost is increased, due to the durability problem when connecting the cover and the aerogel blanket, the problem that it is difficult to implement thermoforming technology because aerogel is made of a material resistant to high temperatures, and processing problems during post-processing of cutting portions.

### DISCLOSURE

### Technical Problem

The present invention has been made in order to solve or mitigate the above-mentioned problems occurring in conventional aerogel blanket processing, and to provide a method for producing an aerogel blanket, which can mitigate the problem that aerogel particles are separated from the blanket during processing, which is one of these problems, and an aerogel blanket produced thereby.

Another object of the present invention is to provide a method for producing an aerogel blanket, which can reduce the difficulty of processing, which is one of the problems occurring in conventional aerogel blanket processing, and an aerogel blanket produced thereby.

### Technical Solution

To achieve the above objects, a method for producing an aerogel blanket according to the present invention comprises steps of:

preparing a blanket (composite material); preparing a liquid raw material for aerogel formation with which the blanket is to be impregnated; impregnating the blanket with the liquid raw material; and gelling the impregnated liquid raw material to form aerogel, wherein a step of performing pre-processing on the blanket is performed before gelling of the liquid raw material is completed.

In the present invention, the step of performing pre-processing may be performed after the step of preparing the blanket but before the step of impregnating with the liquid raw material, or may be performed when the impregnated liquid raw material is in a flowable semi-liquid state or jelly state before an aerogel formation process of converting the liquid raw material into aerogel.

In the present invention, the pre-processing may include quilting, compression, fusion, planar or three-dimensional (3D) molding of the blanket. Here, compression or fusion may be performed on a boundary region of cell compartments, a cutting or perforation portion, or a loss portion after production of the aerogel blanket material.

In the present invention, the blanket may be a cotton or non-woven fabric blanket, an organic or inorganic fiber fabric blanket, a soft synthetic resin foam blanket with an open cell structure, a hard synthetic resin foam blanket with an open cell structure, or a combination including at least one of these blankets. For example, quilting may be often used as pre-processing for a cotton fabric blanket.

Here, as a method of quilting, high-frequency fusion using a pressing mold, thermal fusion, sewing machine quilting using a sewing thread, etc. may be used. In this case, even if the aerogel blanket material is applied to a finished product and repeatedly folded and rolled or rubbed, the aerogel impregnated in the blanket (composite material) may be trapped in the region between the quilted sections, and thus may be prevented from leaning toward one side or clumping together. For example, it is possible to prevent clumping, swelling, or leaning of cotton, that is, insulation.

For example, before the liquid raw material for aerogel formation is impregnated with a gel catalyst, a plurality of cells having various shapes may be formed in an organic and inorganic fiber composite blanket or a foam fabric blanket with open cells by a high frequency/ultrasound/laser/thermal molding or cooling molding apparatus using sewing thread quilting or a mold as pre-processing, and patterns including a plurality of cells or a cell boundary line of each of the plurality of patterns and a cutting portion formed around the pattern may be press-molded.

In the present invention, the blanket is preferably formed of a material capable of maintaining usability at a temperature of −30° C. or less, preferably −60° C., like aerogel, and maintaining material properties at a temperature of, for example, 60° C., preferably 240° C.

In the present invention, when a cover layer is attached by fusion, a pressing unit for performing the fusion may be composed of a pressing mold in which a rubber, silicone, soft plastic, or synthetic fibrous material, which exhibits elasticity when compressed, is laminated onto a roll-shaped, flat-shaped, or 3D-shaped hard metal material. Using this pressing mold, cover layer may be molded and fused to the aerogel blanket.

In the present invention, a cover layer may be formed by impregnating or coating an outer fabric with a mixture of a carbon nanotube, graphene, metal or mineral powder material and an organic material, inorganic material, or organic/inorganic composite material so as to allow rapid diffusion of heat and electricity, and the cover layer may also be formed by molding and fusion. The cover layer may be composed of liquid polyimide or other organic, inorganic, or organic/inorganic composite material, and may be formed by applying or spraying liquid resin or liquefied thermoplastic resin at a certain pressure or higher using a brush or squeegee type device.

In the present invention, the cover layer may also be in the form of a vacuum portion formed by compressing a fabric, obtained by pre-processing a gas barrier film or an organic/inorganic fiber composite, and an outer fabric having a 3D shape overlapping with the edge and cell line of each pattern including a plurality of cells, against a blanket body by means of a vacuum device.

The cover layer may be formed by laminating a steel, plastic, mineral composite, film composite, or fiber composite outer fabric consisting of a 2D- or 3D-shaped thin film onto the aerogel blanket body so as to match the aerogel blanket body.

The cover layer may be composed of a plurality of layers, and at least one of the plurality of layers may be a cover layer formed by combining a fabric heating element and a planar heating element to form a heating unit.

In the present invention, a portion of the cover layer may be in the form of a double-sided tape or sticker, one side of which is attached to the body so that the outer fabric can be adhered to the aerogel blanket body. The cover layer may be processed to have a release film and may be used after removal of the release film upon attachment.

In the present invention, the blanket may have a thickness of 0.1 mm to 30 mm. In the present invention, when the blanket is pre-processed, for example, when a quilting pattern having a plurality of cells is formed and the edge portion or cell line of the pattern is press-molded, the thickness of the compressed line portion may be 0.03 mm to 29 mm.

In the present invention, the liquid raw material undergoes sol-gel conversion and may comprise an inorganic material, an organic material, or a mixture of inorganic and organic materials. In the step of gelling the impregnated liquid raw material, the liquid raw material may be gelled by a catalyst.

In the present invention, a step of forming a cover layer on the surface of the aerogel blanket may be further performed after the gelling (aerogel formation) step. This step may be performed on the aerogel blanket surface on which the aerogel is broken into particles and scatters, after the aerogel formation step performed by an atmospheric pressure method or a supercritical method.

In this case, the cover layer may be composed of a material through which aerogel particles do not leak out, or a material through which aerogel particles do not leak but which has moisture permeability resistance, or a gas barrier material. In addition, the cover layer may be formed by applying various resin materials including liquid polyimide or thermoplastic resin, for example, a raw material consisting of an organic, inorganic or organic-inorganic composite material, or by attaching a laminate of sheets, films or fabrics of different materials.

In the present invention, in the step of forming a cover layer including an outer fabric finishing material including a gas barrier film, a steel-deposited film, or a combination thereof, a vacuum aerogel blanket may be produced by vacuum-pressing the outer fabric using a vacuum device.

In the present invention, fusing of the cover layer in the step of forming the cover layer may also be performed using a method of molding and fusing the cover layer to the aerogel blanket in the same 3D shape as in the pre-processing.

In the present invention, it is also possible to form the impregnation portion blanket through 3D molding during pre-processing before impregnating the blanket with the liquid raw material.

In the present invention, the step of performing pre-processing may be performed after the step of preparing the blanket but before the step of impregnating with the liquid raw material, and additionally when the impregnated liquid raw material is in a flowable semi-liquid state before an aerogel formation process.

In this case, molds having the same shape may be used, and the mold used in the pre-processing performed when the liquid raw material is in the semi-liquid state may be a mold which has the same pattern as that of the mold used before impregnation with the liquid raw material, but has a perforation in a portion (corresponding to the impregnation portion) other than blanket-pressing portions so that the state impregnated with the liquid raw material is maintained well.

In the present invention, when the pre-processing step is performed, it is possible to use a method and device of spraying or applying the liquid raw material in a state in which the blanket is pressed with the perforated mold, and then absorbing aerogel by pushing or pressing the aerogel-impregnation portion against the mold using a roll, squeegee or brush device.

In the present invention, when at least a portion of the pre-processing is performed after impregnation is performed, surplus aerogel raw material solution may be collected and treated using a groove-forming line and a suction device provided at the periphery of the mold after impregnation with the liquid raw material.

### Advantageous Effects

According to the present invention, it is possible to mitigate the problem that aerogel is broken into particles and separated from the aerogel blanket material during processing of the aerogel blanket material for product production, thereby polluting the surrounding environment.

According to the present invention, as a portion of the aerogel blanket material processing operation for product production is performed in advance in the aerogel blanket production step, it is possible to eliminate a portion of the processing operation in the step of producing a product using the aerogel blanket material, and it is possible to prevent or reduce impregnation with the liquid raw material at the fibrous blanket position where processing operations such as cutting or sewing are to be performed. Thus, it is possible to prevent the aerogel from being broken into particles and separated at the processed position during this processing, and it is possible to improve workability due to the absence of aerogel capable of interfering the operations at the corresponding position.

Conventionally, the aerogel blanket is cut and used as a part material, and the space and cutting portions other than the pattern portion including cells are formed by pressing the blanket, impregnated with an aerogel having strong heat resistance, by means of a thermoforming mold, and this processing requires high pressure, high temperature, and a long time. However, according to one aspect of the present invention, molding and processing the blanket before aerogel formation is easier and more convenient than molding and processing the aerogel blanket impregnated with aerogel. In this case, it may also have an effect of preventing contamination from occurring due to separation of aerogel particles.

In more detail, in a previous technology, when the outer material (outer fabric) is fused to a pattern for use as a part material in the aerogel blanket material and cut, the cutting portion is thermally compressed, but due to compression of the aerogel blanket impregnated with aerogel, heat-melting compression is not easily achieved, and the outer film and the blanket are damaged. In particular, due to damage to the outer fabric of the cutting portion, a phenomenon often occurs in which the aerogel particles of the aerogel-impregnated portion leak out in the form of dust due to internal pressure, causing problems in a finished product.

According to the present invention, as the required portion of the aerogel blanket is cut, there is an advantage in that the production process is stabilized and defects and work process risks are greatly reduced.

In addition, as unnecessary cutting portions and loss portions are not converted into aerogel from the very beginning, there is the advantage of saving a sol-gel raw material and raw materials and time required for hydrophobic treatment, and as the process of laminating an outer fabric onto the aerogel blanket is added, there is an advantage in that the aerogel blanket may be mass-produced as finished products such as necessary interior finish insulation materials, interior materials, and parts. Thus, the aerogel blanket whose application has been limited due to dust scattering of aerogel particles, is applied and used as parts materials and finished products for various applications, applicability and workability thereof can be improved.

In addition, as an example, it has been difficult to apply the aerogel blanket as a part material having a shape to automobiles, aviation, industrial equipment, and various plant part materials, but according to the present invention, 2D and 3D molding of the aerogel blanket can greatly alleviate the problem of requiring a lot of time and high temperature due to the heat resistance of impregnated aerogel.

Even in the case of surface treatment to cover the aerogel blanket with an outer fabric, the present process of molding and processing the aerogel blanket solves the problem that the outer moisture-permeable film or the blanket is damaged due to high pressure and high temperature. In addition, the post-stage production process of attaching the outer fabric is possible even at low temperature or with a general low-temperature adhesive, thus greatly contributing to improving the process without damaging the blanket and the outer film. Even when the present invention is applied to industrial fields in the future, it does not cause difficulties in applying the related industry to the production process, so that the present invention can be applied to all industrial fields by overcoming limitations in industrialization of existing aerogels.

### BRIEF DESCRIPTION OF DRAWINGS

FIGS. 1 and 2 are top views of insulating blankets showing conventional examples in which aerogel is divided into compartments and the compartments are separated from each other by a region having a width.

FIG. 3 is a flow chart showing a conventional method of producing a conventional aerogel blanket material.

FIG. 4 is a flow chart showing a method for producing an aerogel blanket material according to a first embodiment of the present invention.

FIG. 5 is a top view showing a state in which a blanket has been prepared and pressing/heating pre-processing has been performed on a portion to be cut, according to the first embodiment of the present invention.

FIG. 6 is a sectional view taken along line A-A′ in FIG. 5.

FIG. 7 is a sectional view showing a state in which an aerogel blanket has been formed by performing aerogel impregnation in the state of FIG. 6.

FIG. 8 is a sectional view showing a state in which a cover layer has been formed on the surface of the aerogel blanket in the state of FIG. 7.

FIG. 9 is a flow chart showing a method for producing an aerogel blanket material according to a second embodiment of the present invention.

FIG. 10 is a flow chart showing a method for producing an aerogel blanket material according to a third embodiment of the present invention.

FIG. 11 is a sectional view showing a state in which pre-processing of the blanket has been performed before and after impregnating the fibrous blanket with a liquid raw material for aerogel formation according to the third embodiment of the present invention.

FIG. 12 is a top view showing a state in which a blanket has been prepared and pressing/heating pre-processing has been performed on a portion to be cut, according to a fourth embodiment of the present invention.

FIG. 13 is a sectional view taken along the line indicated in FIG. 12.

FIG. 14 is a flow chart showing a method of producing another type of aerogel blanket material by performing an additional process on the product obtained by the method shown in, for example, FIG. 10, according to another embodiment of the present invention.

FIG. 15 is a process view schematically showing an example of the method shown in FIG. 14.

FIG. 16 shows a top view schematically showing an example of a mold that may be used for second pre-processing, and a sectional view of a portion thereof.

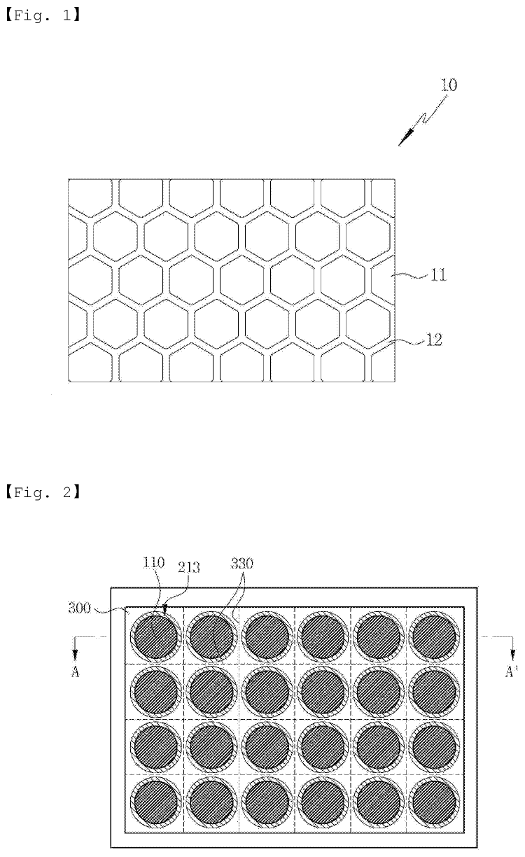

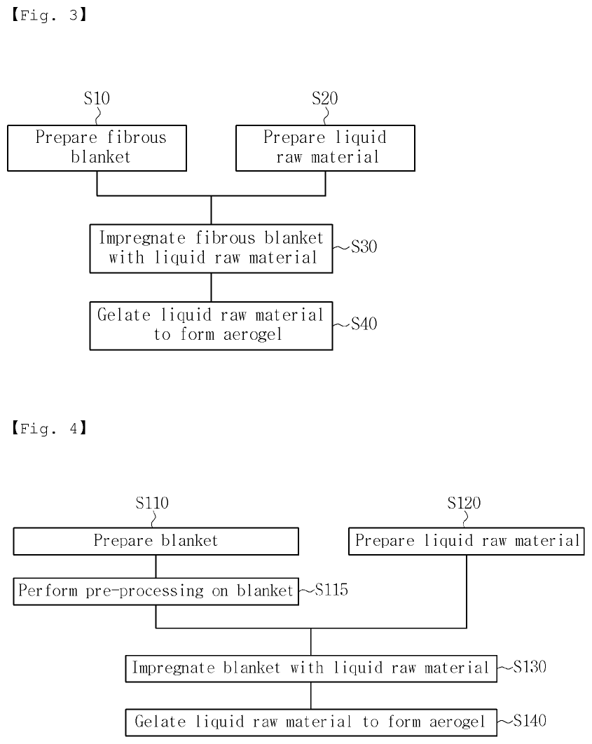

### MODE FOR INVENTION

Hereinafter, embodiments of the present invention will be described in more detail with reference to the accompanying drawings.

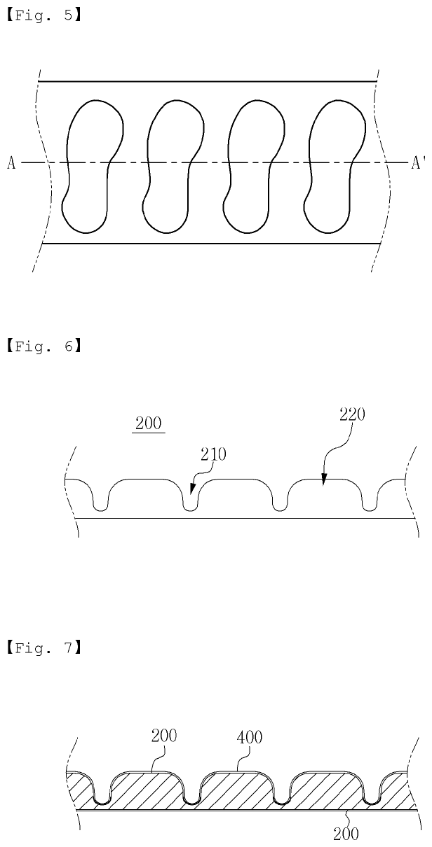

FIG. 4 is a flow chart showing a method for producing an aerogel blanket material according to a first embodiment of the present invention. Here, step (S110) of preparing a fibrous blanket and step (S120) of preparing a liquid raw material for aerogel formation with which the fibrous blanket is impregnated may be performed separately in any order.

However, unlike a conventional method for producing an aerogel blanket, this embodiment further includes step (S115) of preparing a pre-processed fibrous blanket by pre-processing the prepared fiber fabric following the process of preparing the fibrous blanket.

After each of the liquid raw material and the pre-process fibrous blanket is prepared as described, step (S130) of impregnating the pre-processed fibrous blanker with the liquid raw material is performed. Subsequently, the impregnated liquid raw material is converted into aerogel through a conventionally known aerogel production process (S140).

The pre-processing may be variously performed by quilting, compression, fusion, or a combination thereof on a certain portion of the fibrous blanket, and the fibrous blanket may be formed of one of cotton, nonwoven fabric, and woven fabric. Here, the fibers may be both natural fibers and artificial fibers, and in terms of material, both organic fibers and inorganic fibers are possible.

Although the fibrous blanket is used here, the blanket is not necessarily limited to the fibrous blanket, and it is also possible to use porous foam such as a sponge as the blanket and impregnate the same with the liquid raw material for aerogel formation.

When the fibrous blanket is formed of cotton, the aerogel blanket production process may be performed by quilting the cotton blanket overall and impregnating the same with the liquid raw material for aerogel formation. In addition, when a cutting line for product production is formed on a nonwoven fabric made of thermoplastic synthetic fiber and having a certain thickness, pre-processing of forming a cutting line having a certain width by pressing the cutting line position by a heating and pressing method using an embossed flat plate or roller may be performed, and then the aerogel blanket production process may be performed by impregnating the blanket with the liquid raw material.

In this case, the pressed cutting line may be considered to include an unnecessary portion that is not used when using the aerogel blanket, and the cutting line may play a role in preventing the liquid raw material from being impregnated, by minimizing porosity by thermal compression.

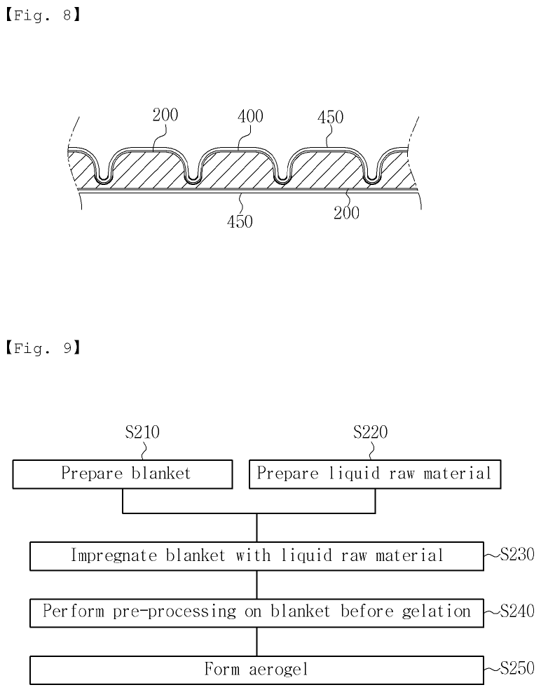

FIGS. 5 and 6 are a top view and sectional view showing that a cutting line 210 is formed in a fibrous blanket 200 by pre-pressing processing in the first embodiment of the present invention.

The portion indicated by the closed curve in FIG. 5 becomes the cutting line 210 in FIG. 6, which is a processed portion formed thinly by pressing, and the remaining portion becomes the non-processed portion 220 having a thickness corresponding to a state in which the fibrous blanket impregnated with the liquid raw material is first formed.

When the blanket 200 in the state of FIG. 6 is impregnated with the liquid raw material 400, the entire blanket is impregnated with the liquid raw material and becomes a state shown in FIG. 7. In FIG. 7, the impregnated liquid raw material exists up to the surface of the blanket 200, and is denoted by reference number 400.

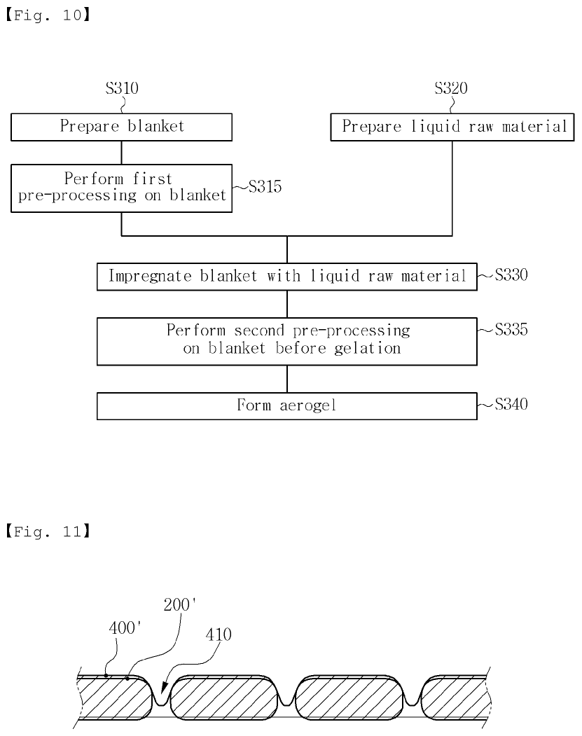

The liquid raw material 400 may be gelled in various ways as in a conventional art, and then a cover layer 450 may be formed on the surface as shown in FIG. 8, thereby producing the aerogel blanket of this embodiment.

Compared to the state of FIG. 7, the cover layer 450 is further formed on the surface as shown in FIG. 8. This cover layer 450 forms the surface of the aerogel blanket material, and one characteristic of the aerogel blanket material may be achieved depending on the material of the cover layer.

In this aerogel blanket material, the cutting line portion may be used to perform a cutting process for the aerogel blanket material or facilitate a sewing process. In particular, the impregnated and gelled aerogel is entirely covered by the cover layer, and even if a portion of the aerogel layer is formed and present in the pre-processed cutting line portion in the impregnation and gelling steps, it is covered by the cover layer. Thus, in a post-processing process, such as aerogel blanket material cutting for product production, the problem that the aerogel in this portion is broken into particles and separated may also be suppressed by the cover layer, and thus the problem may be further mitigated.

When the cover layer is fused in the step of forming the cover layer, the aerogel blanket may be produced by a method of molding and fusing aerogel in a 3D shape using a double-sided mold for heat pressing so that the aerogel blanket material may be formed in 3D. This is to provide three-dimensional (3D) aerogel blanket parts suitable for insulation to industrial parts and household aerogel parts that can be directly provided as parts requiring 3D molding.

Here, the cover layer may be made of various materials, and as the shape or type of pre-processing adopted according to the characteristics of the fibrous blanket is affected, the type of fibrous blanket is adopted. In addition, depending on the type of pre-processing and the step in which pre-processing is performed, whether the cover layer is formed, the material of the cover layer, and the method of forming the cover layer may be selected in various manners.

For example, the cover layer may be formed by a process of applying and curing synthetic resin, or attaching other fibrous fabric through an adhesive or heat fusion processing, or attaching a fibrous fabric through sewing.

For example, in the case of a cotton fabric, the cover layer may be formed by a process of applying and curing a polyimide or thermoplastic liquid raw material. For thermal fusion, the fiber fabric is preferably made of thermoplastic synthetic fiber, and in the case of a natural fiber fabric, the cover layer may be attached by an adhesive or sewing.

As the cover layer, a liquid raw material such as PTFE or polyurethane (PU) may be applied, and a film including moisture-permeable pores and pore structures having a size through which aerogel dust does not leak out may also be used as a film suitable for the human body or various heat insulation structures requiring a moisture-permeable waterproof layer.

In this embodiment, the non-processed portion 220, a non-pre-processed portion of the fibrous blanket, is a portion which is sufficiently impregnated with the liquid raw material for aerogel formation and gelled and in which fiber tissue and an aerogel with a large number of pores are present together.

Meanwhile, the portion of the cutting line 210 that has been pressed is a portion compressed by pressure in the pre-processing step, and this portion has low elasticity and a large number of pores are removed therefrom in the pre-processing step, and thus this portion is hardly impregnated with the liquid raw material. Therefore, even when this portion is cut later, the phenomenon in which the aerogel in this portion is broken into particles and leaks into the surrounding environment may be suppressed.

In the above-described first embodiment, the pre-processing is performed before the fibrous blanket is impregnated with the liquid raw material, but in some embodiments, the pre-processing may also be performed when the liquid raw material impregnated in the fibrous blanket is in a flowable semi-liquid state before being completely converted into aerogel.

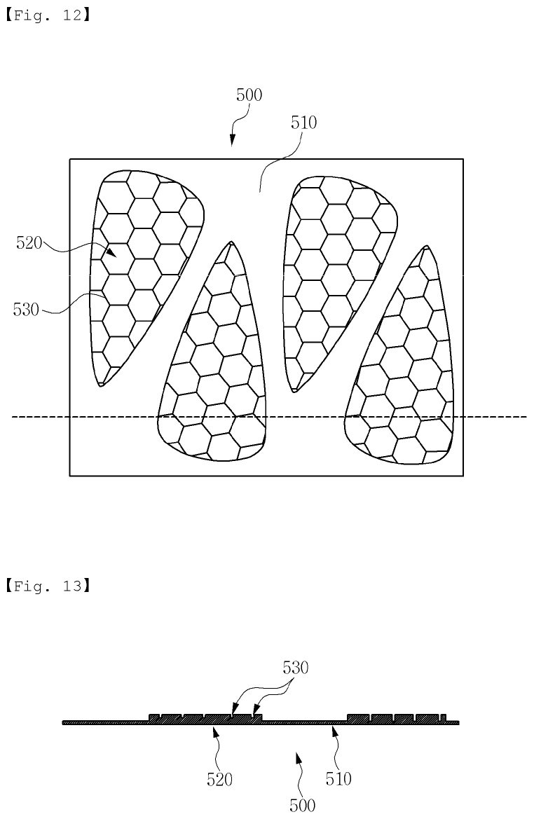

FIG. 9 is a flow chart showing a method for producing an aerogel blanket material according to a second embodiment of the present invention. Here, step (S210) of preparing a fibrous blanket and step (S220) of preparing a liquid raw material for aerogel formation with which the fibrous blanket is to be impregnated are separately performed, and step (S230) of impregnating the fibrous blanket with the liquid raw material is performed after each of the liquid raw material and the fibrous blanket is prepared.

However, unlike a conventional method for producing an aerogel blanket, this embodiment further includes step (S240) of pre-processing the blanket before gelling. In this step, pre-processing is performed on a certain portion (e.g., cutting portion) of the fibrous blanket when the liquid raw material after impregnation is in a flowable semi-liquid state or jelly state before being completely gelled, thereby removing the aerogel raw material in a semi-liquid state from this portion of the fibrous blanket. Through these steps, a state similar to that shown in FIG. 7 for the first embodiment may be obtained.

Subsequently, the semi-liquid raw material for aerogel formation is completely converted into aerogel by a conventionally known gelation process (S250).

FIG. 10 is a flow chart showing a method for producing an aerogel blanket material according to a third embodiment of the present invention.

The third embodiment includes both a step of performing pre-processing on the fibrous blanket before impregnation with the liquid raw material as in the first embodiment, and a step of performing pre-processing on the fibrous blanket after impregnation with the liquid raw material but before gelling as in the second embodiment.

More specifically, the third embodiment also includes step (S310) of preparing a fibrous blanket and step (S320) of preparing a liquid raw material for aerogel formation with which the fibrous blanket is to be impregnated, which are performed separately, and also includes step (S330) of impregnating the fibrous blanket with the liquid raw material, and step (S340) of completely gelling the liquid raw material to form aerogel through a conventionally known gelation process.

In addition, the third embodiment further includes a first pre-processing step (S315) after the step of preparing the fibrous blanket but before impregnation with the liquid raw material, similar to the first embodiment, and a second pre-processing step after impregnation with the liquid raw material but before complete conversion into aerogel, similar to the second embodiment.

In this embodiment, the portion processed in the first pre-processing step (S315) and the portion processed in the second pre-processing step (S335) may be completely coincident with each other, but may also be at different positions and be obtained by different processing methods.

For example, in the first pre-processing step, a cutting portion may be formed by heating and pressing, and in the second pre-processing step, only simple pressing may be performed. For simple pressing in the second pre-processing step, the raw liquid material uses a combustible raw material for solvent substitution during the aerogel formation process, and in this case, simple pressing in the second pre-processing step may serve to remove the liquid raw material from the cutting portion and collect the same in the impregnated portion.

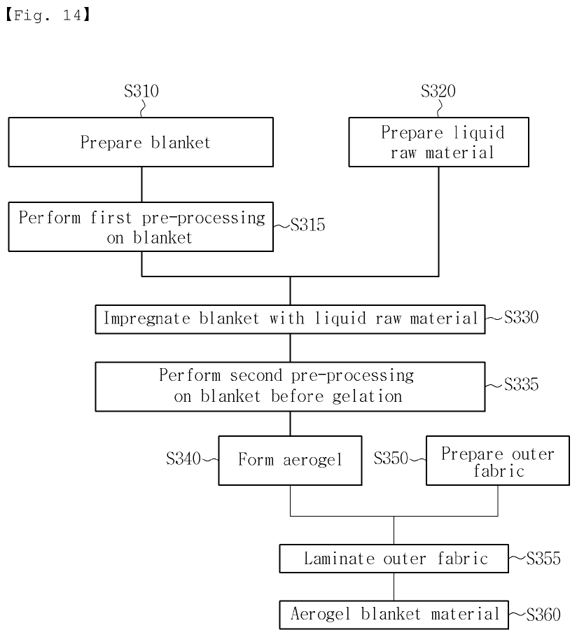

FIG. 11 is a sectional view showing one side cross section of the aerogel blanket produced according to the method shown in FIG. 10.

As shown therein, first pre-processing is performed by heating and pressing the cutting line portion in a non-woven fabric blanket having a considerable thickness and made of synthetic resin fiber. Thereby, the cutting line portion in the form of a synthetic resin film is solidified after the melting by the heating rather than having a fibrous structure. This portion is hardly impregnated with the liquid raw material in the impregnation step, and therefore, aerogel having a large number of pores is hardly formed in this portion.

However, even though this portion is not impregnated with the liquid raw material for aerogel formation, a thin aerogel raw material layer can be formed on the surface thereof. In this embodiment, the cutting portion is pressed through the second pre-processing so that the semi-liquid raw material layer on the surface is pushed aside and removed. As another method, an air suction portion may be formed around a protruding mold and used to remove the aerogel raw material layer from the surface of the cutting portion.

Thus, when the aerogel blanket is formed through the subsequent gelation process, the aerogel is impregnated throughout the thickness of the fiber in a non-processed portion 400′ of a fibrous blanket 200′ to form a pore-rich porous layer, and the aerogel layer almost does not exist on the surface of the processed portion unit 410 which is the cutting line.

When cutting or sewing is performed on the aerogel blanket material using this cutting line, the problem that the aerogel in this portion is broken into particles and separated during the processing does not occur or may be significantly mitigated. Of course, in this embodiment, it is also possible to form a cover layer through a subsequent process step.

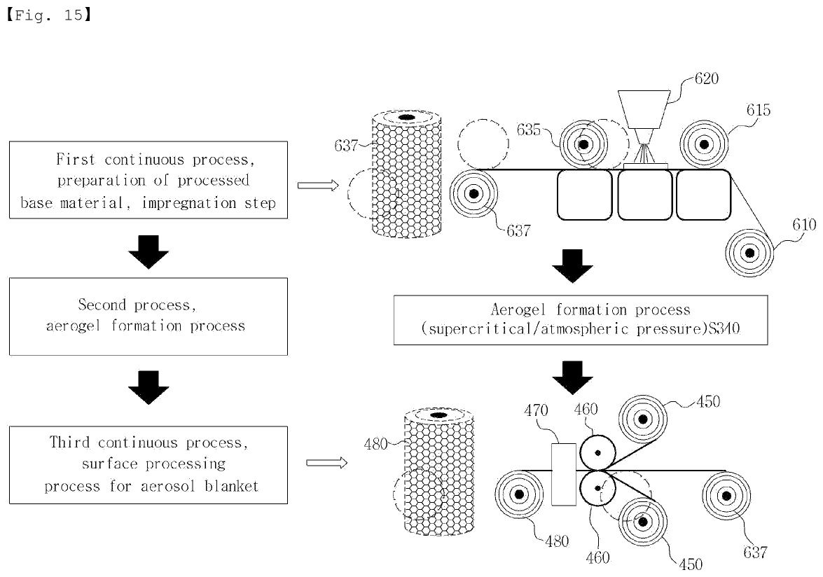

FIGS. 12 and 13 are a top view and sectional view showing a state in which a fibrous blanket 500 has been processed to be divided into a use portion 520 and a blank portion 510 by pre-processing including heating and pressing before impregnation with the liquid raw material, and a cutting line has been formed at the boundary between the use portion and the blank portion, and a sewing line 530 for quilting has been formed throughout the entire area of the use part, according to the forth embodiment.

In this case, the blank portion and the cutting line may be formed through the same heating and pressing process, and when the blanket is made of thermoplastic synthetic resin fiber, this portion is melted and solidified to become a portion that cannot be impregnated with the liquid raw material, that is, a portion having no empty space or pores.

The sewing line portion for quilting may be formed through a quilting process separately from the cutting line, and quilting may be performed by a process using high frequency, heat fusion, or sewing thread with a mold or a sewing quilting machine. The quilting line may be composed of a straight line, a dotted line, etc., and this portion may serve to reduce the thickness by pressing the fibrous blanket while performing the original function of quilting.

In this case, the blank portion and the cutting line are hardly impregnated with the expensive liquid raw material for aerogel formation during impregnation of the pre-processed fibrous blanket with the liquid raw material for aerogel formation, and thus material waste can be prevented. In addition, the problem caused by the generation of aerogel particles during processing of the aerogel blanket material may be eliminated, and processing convenience may be increased. The sewing line portion for quilting is also less impregnated with the liquid raw material for aerogel formation, and thus a similar effect can be obtained.

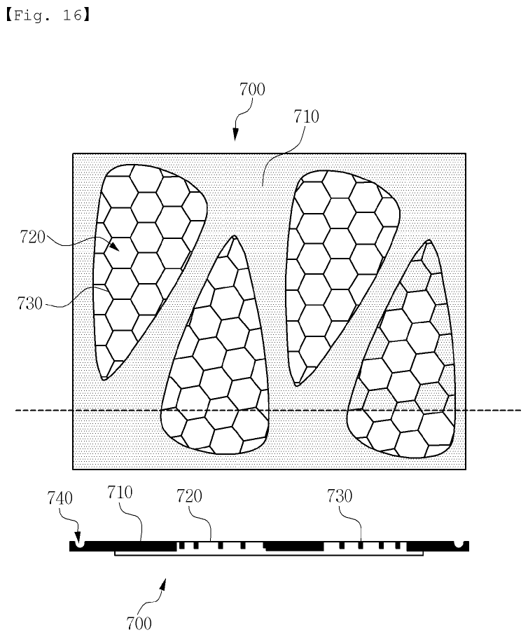

FIG. 14 is a flow chart showing a method of producing another type of aerogel blanket material by performing an additional process on a product obtained by, for example, the method of the third embodiment, according to another embodiment of the present invention, and FIG. 15 is a process view schematically showing an example of the method shown in FIG. 14.

Here, the present applicant proposes the method of this embodiment as a way to solve the technical problems related to the application of the above-mentioned conventional aerogel blanket. In this method, a base fabric constituting the blanket of the aerogel blanket is first prepared before the aerogel production process during the aerogel blanket production process (S310). The base fabric may be organic or inorganic fiber, such as insulating material, non-woven fabric, woven fabric, or porous foam with open cells. A process of pre-quilting this base fabric making the base fabric into a material including cells having various shapes using sewing thread, or a first pre-processing process of processing the base fabric into a pattern shape having a combination of a plurality of small cells suitable for use as a part material by two-dimensional (2D) or three-dimensional (3D) molding is performed (S315), and a process of impregnating the pre-processed base fabric with the aerogel sol-gel liquid raw material prepared in step S320 and partially gelling the liquid raw material is performed (S330). Then, a second pre-processing process of removing the partially gelled portion from the cutting portion or the loss portion is performed (S335). Thus, a product is primarily formed by the first pre-processing including the molding and aerogel sol-gel solution impregnation process and the second pre-processing.

Thereafter, aerogel formation is performed by an atmospheric pressure method and a supercritical method (S340), and then an outer fabric lamination process (S355) of laminating the outer fabric prepared in step S350 to provide a finished product from which dust does not scatter upon the application of the aerogel blanket product is performed, and an aerogel blanket material is obtained (S360).

Thus, it is possible to provide the aerogel blanket in a roll or sheet form by converting it into a part material to be applied directly to each application. During the aerogel blanket production process, a process (first continuous process) including forming and quilting a pattern having cells, forming a cutting portion, and 3D molding is performed prior to the aerogel formation process. This aerogel blanket production method improves the applicability of the produced aerogel blanket to a part material for a finished product.

More specifically, regarding impregnation of a fibrous composite 610 with a raw liquid material 620 for aerogel formation, this embodiment discloses a process of partially impregnating the fibrous composite with the liquid raw material for aerogel formation, unlike a process of impregnating the entire portion of the fibrous composite. The cell pattern boundary line or sewing line and cutting portion formed in the fibrous composite by the first pre-processing (S315) is a portion forming a concave groove in the fibrous composite. Thus, the liquid material 620 may be deposited or accumulated in the groove portion, and thus a problem may occur in the process of laminating the cover layer 450, which is the outer fabric, in a subsequent production process (third continuous process). For this reason, second pre-processing may be performed by pressing the groove portion (formed by pressing) again with a mold having substantially the same shape as the first pre-processing mold 615, thereby obtaining an aerogel blanket material 637 in a roll form.

The mold for second pre-processing may be provided on the surface of a roller, and when it is formed flat, a flat mold 700 having a protruding portion to press the concave groove portion in which the liquid material 620 for aerogel formation has been deposited or accumulated may be obtained as shown in FIG. 16.

In the flat mold 700, the loss portion 710, the cutting portion, and the cell-shaped quilting portion 730 are portions that protrude relatively from the mold to press the corresponding portion or groove portion of the fabric, and may serve to remove the liquid material for aerogel formation or partially gelled material by moving the same to the surrounding portion.

In the flat mold 700, the remaining portion 720 corresponding to the fibrous composite portion impregnated with the raw material for aerogel formation or the stock solution may be relatively concave or perforated so as to be exposed.

By pressing with the mold 700 shown in FIG. 16, the raw material liquid material for aerogel formation is removed from the groove portion of the fibrous composite, and the portion where impregnation should continue is continuously impregnated with the liquid raw material for aerogel formation. In this case, a groove 740 may be formed at the periphery of the mold, and surplus raw material solution to be removed may be collected in the groove 740.

In addition, partial impregnation is performed using a method of spraying or injecting, like a conventional impregnation method, but when the fibrous composite (blanket material) is to be impregnated with the liquid raw material for aerogel formation, the organic/inorganic fibrous composite fabric subjected to first pre-processing may be pressed with a mold having a perforation in a portion corresponding to the impregnation portion, and in this state, a predetermined amount of the liquid raw material may be applied, and then the aerogel-impregnation portion may be pushed against the mold using a squeegee device, thereby absorbing the liquid raw material. Using this device, the composite fabric may be partially impregnated with the liquid raw material.

The method of partially impregnating the fabric composite with the liquid raw material may exhibit the effect of stabilizing the process and reducing the raw material for unnecessary portions in the subsequent production process (third continuous process). Following the previous production process (first continuous process) in which pre-processing is performed, the impregnated liquid raw material may be converted into aerogel through a conventionally known aerogel production process (second process).

The pre-processing may be performed in various manners by quilting, pressing, fusion, or a combination thereof on a certain portion of the fibrous fabric, and for this purpose, a mold with various patterns and cells is used, and a roll forming or press forming device is preferably used. The fibrous blanket may be formed of one of cotton, nonwoven fabric, and woven fabric. Here, the fibers may be both natural fibers and artificial fibers, and in terms of material, both organic fibers and inorganic fibers are possible.

Although the fibrous blanket is used here, the blanket is not necessarily limited to the fibrous blanket, and it is also possible to use porous foam such as a sponge as the blanket and impregnate it with the liquid raw material for aerogel.

In the case of a cotton blanket, a cover layer may be formed by applying and curing a polyimide or thermoplastic liquid raw material in a subsequent production process, and for thermal fusion of the cover layer to the blanket, a thermoplastic synthetic fiber cover layer or a synthetic fiber cover layer treated with an adhesive layer having non-thermal adhesiveness may be used.

In the process of applying liquid polyimide, organic, inorganic, or organic/inorganic composite liquid thermoplastic resin in the step of forming the cover layer, the liquid material is preferably applied by a brush or squeegee device capable of applying the liquid material at a certain pressure or higher.

A fabric laminated onto the cover layer may consist of a fabric formed by combining a fabric heating element and a planar heating element to form a heating unit. As another method, an adhesion portion may be formed on one side of the aerogel blanket so as to be used as an adhesive tape for the application target, so that the outer surface of the laminated aerogel blanket is in the form of a sticker to which a release film is attached. Thus, a fabric or film having an adhesive formed thereon may be obtained.

In addition, a portion of the outer fabric may be one obtained by laminating a 2D- or 3D-shaped organic, inorganic, or organic/inorganic composite material onto a steel, plastic, film composite or fiber composite material (including carbon fiber, glass fiber, or ceramic fiber) in 3D configuration so as to be consistent with the molded and processed shape of the aerogel blanket. This is to optimize application as a finished material by pre-processing the outer surface material forming the outer layer in 2D or 3D and laminating the same.

As another method, there may be proposed a method of producing an aerogel blanket by molding and fusing aerogel with a cover layer formed by coating an outer fabric with a mixture of a carbon nanotube, graphene, metal or mineral powder material and an organic material, inorganic material, or organic/inorganic composite material so as to allow rapid diffusion of heat and electricity, in order to absorb electromagnetic waves or reduce radiant heat.

In the case of natural fiber fabric, the cover layer may be mainly attached through an adhesive or sewing.

Through the step of preparing and laminating the outer fabric, an aerogel blanket material can be made, from which aerogel particle dust does not blow out and aerogel particles do not leak out even if the necessary portions are cut.

When a part material processing operation is performed on the aerogel blanket material for application to a finished product, for example, when the aerogel particles impregnated in the aerogel blanket are repeatedly bent, folded, rolled, or rubbed, the base material may be deformed or the aerogel may be separated from the base material or leaned to one side. To prevent this problem, a process of forming cells having a certain pattern is performed through quilting or molding pressing.

In this case, the blanket impregnated with aerogel is a material that reacts to high temperatures due to the characteristics of silica aerogel, and aerogel is impregnated into the base material blanket made of an organic and inorganic fiber composite, and thus thermal reaction of the base material blanket does not easily occur, thus making it difficult for cell formation work for confining aerogel particles in a certain area or 3D molding of cutting lines, or make it unstable even after molding.

Also, even in the case of sewing quilting, the friction of the aerogel particles may interfere with repeated movement of sewing thread and a needle between the top and bottom of the aerogel blanket and passage thereof through the aerogel blanket, or allows the sewing needle to be easily worn or the sewing thread to be cut off.

According to this embodiment, this problem can be easily overcome through the process performed before the aerogel formation process (second process) in the aerogel blanket production process.

Although the present invention has been described with reference to the illustrated embodiments, this description is only exemplary those skilled in the art will appreciate that various modifications can be made therefrom and all or some of the above-described embodiments may be selectively combined and implemented. Therefore, the true technical scope of the present invention should be defined by the technical spirit of the appended claims.

1. A method for producing an aerogel blanket, the method comprising steps of:
preparing a blanket;
preparing a liquid raw material for aerogel formation with which the blanket is to be impregnated;
impregnating the blanket with the liquid raw material; and
gelling the impregnated liquid raw material to form aerogel,
wherein a step of performing pre-processing on the blanket is performed before gelling of the liquid raw material is completed.

2. The method of claim 1, wherein the pre-processing is performed before impregnating with the liquid raw material, or is performed when the impregnated liquid raw material is in a flowable semi-liquid state before the liquid raw material is completely converted into aerogel.

3. The method of claim 1, wherein the pre-processing comprises at least one of quilting, pressing and fusion on a portion of the blanket.

4. The method of claim 1, wherein the blanket comprises at least one of cotton, non-woven fabric, organic or inorganic fiber woven fabric, soft synthetic resin foam with an open cell structure, and hard synthetic resin foam blanket with an open cell structure.

5. The method of claim 1, further comprising, after the step of gelling, a step of forming a cover layer on a surface of the aerogel blanket.

6. The method of claim 5, wherein the step of forming the cover layer is performed by applying a polyimide or thermoplastic resin raw material or attaching a separate fabric.

7. The method of claim 5, wherein the cover layer is composed of a resin raw material or film having moisture permeability resistance, or is formed by press-attaching a gas barrier film using a vacuum device.

8. The method of claim 1, wherein the pre-processing comprises first pre-processing which is performed before impregnating with the liquid raw material, and second pre-processing which is performed when the impregnated liquid raw material is in a flowable semi-liquid state before the liquid raw material is completely converted into aerogel.

9. The method of claim 3, wherein the quilting is performed by one of high-frequency fusion using a pressurized mold, thermal fusion, and sewing machine quilting using a sewing thread, so that even if the aerogel blanket is applied to a finished product and repeatedly folded, rolled or rubbed, the aerogel impregnated in the blanket is trapped in a compartment surrounded by quilted sections and prevented from leaning toward one side or clumping together, and clumping, swelling, or leaning of insulation is prevented.

10. The method of claim 1, wherein the blanket is formed of a material capable of maintaining its properties at a temperature from −60° C. to 240° C.

11. The method of claim 5, wherein the cover layer is formed by fusion, and a pressing unit for performing the fusion is composed of a pressing mold in which a rubber, silicone, soft plastic, or synthetic fibrous material, which exhibits elasticity when compressed, is laminated onto a roll-shaped, flat-shaped, or 3D-shaped hard metal material.

12. The method of claim 5, wherein the cover layer is formed by impregnating or coating an outer fabric with a mixture of a carbon nanotube, graphene, metal or mineral powder material and an organic material, inorganic material, or organic/inorganic composite material so as to allow rapid diffusion of heat and electricity.

13. The method of claim 5, wherein the cover layer is formed by applying or spraying liquid resin or liquefied thermoplastic resin at a predetermined pressure or higher, and a brush or a squeegee is used to apply the liquid material.

14. The method of claim 8, wherein, as molds for the pre-processing, a mold used for the pre-processing performed when the liquid raw material is in a semi-liquid state is a perforated mold that has the same pattern as that of a mold used before impregnating with the liquid raw material, but has a perforation in a portion (corresponding to the aerosol-impregnation portion) other than blanket-pressing portions so that the state impregnated with the liquid raw material is maintained well.

15. The method of claim 1, wherein, when the pre-processing is performed, the blanket is pressed with the perforated mold, and in this state, the liquid raw material for aerogel formation is sprayed or applied, and then the aerogel-impregnation portion is pushed or pressed against the mold using a roll, squeegee or brush device, thereby absorbing the aerogel.

16. The method of claim 1, wherein, when at least a portion of the pre-processing is performed in a state in which the blanket has been impregnated, surplus liquid raw material during impregnation with the liquid raw material is collected and treated using a groove line formed at a periphery of the mold and a suction device.

17. The method of claim 1, wherein an impregnated portion of the blanket forms a 3D molded portion during the pre-processing but before impregnation with the liquid raw material.

18. An aerogel blanket produced by the method of claim 1.
